(19) United States
(12) Patent Application Publication
(10) Pub. No.: US 2002/0116327 A1
(43) Pub. Date: Aug. 22, 2002

(54) System and methods for syndication of financial obligations

(76) Inventor: Venkatesan Srinivasan, Framingham, MA (US)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 10/010,767

(22) Filed: Dec. 4, 2001

Related U.S. Application Data
(60) Provisional application No. 60/251,077, filed on Dec. 4, 2000.

(51) Int. Cl. G06F 17/60

(52) U.S. Cl. 705/38

(57) ABSTRACT

A system and method for syndicating financial obligations, such as loans, leases, letters of credit, lines of credit, factoring arrangements, and so on. The financial obligations may be prospective obligations, i.e., the obligations may not yet be assumed by any party, or be existing obligations, i.e., the obligations may have been already assumed by at least one entity. An example of a prospective financial obligation may be a loan application that has not yet been approved, but that is being syndicated in an effort to approve a portion of the loan application. Syndication partners may be automatically selected and requested to join in a syndication of one or more financial obligations.

### RELATED APPLICATIONS

This application claims the benefit of the filing date of U.S. application Ser. No. 09/684,208, filed Oct. 6, 2000, which is hereby incorporated by reference in its entirety. U.S. Provisional Application Serial No. 60/251,077, filed Dec. 4, 2000 is also incorporated by reference in its entirety.

### FIELD OF THE INVENTION

This invention relates to syndication of financial obligations using a communications network.

### BACKGROUND OF THE INVENTION

Syndication of financial obligations, such as loan obligations, can be a useful way for lenders and other entities to spread their risk associated with the financial obligation. The term financial obligation is used herein to refer to a loan, factoring arrangement, credit line, lease, letter of credit, or other obligation of a lender or other entity. These various obligations may involve some benefit to the lender or other entity that assumes at least a portion of the obligation, such as interest payments made on a loan amount extended by a lender, as well as obligations on the entity, such as supplying a principle amount for a loan.

By spreading the risk of one or more financial obligations amongst many partners, the various partners can enjoy some security in that if a financial obligation becomes a money-losing deal for a lender, the loss will be shared amongst many partners with each responsible for only a fraction of the total exposure. For example, a lender may extend a loan to a customer. The lender may then break that loan up into ten pieces, retaining one piece for itself, and syndicating the remaining nine pieces amongst nine different lenders. If the loan becomes a money-losing deal, e.g., the customer does not repay the loan principal and/or interest, the loss may be shared (equally or in some other distribution, as the case may be) between the ten partners in the syndication.

Entities may syndicate single financial obligations, such as the loan in the situation described above, or portfolios of financial obligations. A portfolio of financial obligations may include a variety of different types of financial obligations, such as loans, leases, lines of credit, etc., or may include financial obligations of one type, such as a portfolio of several different loans. A lender holding a portfolio of such financial obligations may syndicate the portfolio, e.g., by having other partners assume one or more individual financial obligations within the portfolio, or portions of one or more obligations within the portfolio. The benefits of such syndication can be the spreading of risk posed by the portfolio, among the syndication partners.

### SUMMARY OF THE INVENTION

Illustrative embodiments in accordance with various aspects of the invention provide a system and method for syndicating financial obligations arising from transactions such as loans, leases, letters of credit, lines of credit, factoring arrangements, and so on. The financial obligations may be prospective obligations, i.e., the obligations may not yet be assumed by any party (i.e., commitments), or be existing obligations, i.e., the obligations may have been already assumed by at least one entity. An example of a prospective financial obligation may be the obligation to finance a loan application that is in the approval process, which is being syndicated in an effort to approve all or a portion of the requested loan. An example of an existing obligation may be a loan application that has already been approved by a lender.

In one aspect of the invention, a system for syndicating financial obligations includes a process controller that receives information regarding a financial obligation of a first entity that has not been approved by the first entity. The financial obligation may be, for example, a loan that has not yet been approved by the first entity. The system may also include a syndication module that automatically sends information regarding the financial obligation to prompt a decision from a second entity, different from the first entity, about assuming at least a portion of the financial obligation. For example, the syndication module may send a computer-readable electronic message that causes a computer-implemented module to determine whether a second entity will enter into a syndication of the loan.

In another aspect of the invention, a method for syndicating financial obligations includes receiving electronic information regarding a potential financial obligation of a first entity that has not been approved by the first entity, and automatically sending information regarding the financial obligation to prompt a decision from a second entity, different from the first entity, about assuming at least a portion of the financial obligation.

In another aspect of the invention, a system for syndicating financial obligations includes a process controller that receives information regarding an actual or potential financial obligation of a first entity. A syndication module may identify at least one second entity different from the first entity as a possible syndication partner regarding the financial obligation, without prompting from the at least one second entity. That is, the syndication module may identify a second entity without the second entity previously indicating any interest in becoming involved in a particular syndication transaction (though the second entity may or may not have indicated an interest in becoming involved in syndication, in general). For example, the syndication module may analyze a financial obligation and determine that a particular lender or group of lenders may be interested in joining a syndication of the financial obligation. The syndication module may also automatically send information regarding the financial obligation to prompt a decision from the at least one second entity to assume at least a portion of the financial obligation. Thus, the syndication module may send information to a lender or group of lenders (or to computer-implemented modules operating under the authority of the lenders) that were previously identified, to request the lenders to join in a syndication.

In another aspect of the invention, a method for syndicating financial obligations includes receiving electronic information regarding a financial obligation (actual or potential) of a first entity. In one illustrative embodiment, the electronic information may be a computer-readable message or group of messages that represent an application for a loan. A second entity may be automatically selected as a possible syndication partner, and information may be automatically sent regarding the financial obligation, to prompt a decision from a second entity about assuming at least a portion of the financial obligation. For example, the second entity may be selected based on various criteria, such as a risk posed by the loan or loan application, and the information automatically sent may represent a request for the second entity to consider entering into a syndication of the loan or a group of loans or other financial obligations.

In another aspect of the invention, a method for syndicating at least one loan obligation includes receiving electronic information regarding a loan obligation of a first entity, automatically selecting a second entity different from the first entity as a possible syndication partner in a syndication of the loan obligation, and automatically sending computer readable information regarding the loan obligation to prompt a decision from a second entity about assuming at least a portion of the financial obligation.

These and other aspects of the invention will become apparent from the following detailed description and claims.

### BRIEF DESCRIPTION OF THE DRAWINGS

Illustrative embodiments in accordance with aspects of the invention are described with reference to the following drawings in which like numerals reference like elements, and wherein:

FIG. 1 is a schematic block diagram of a financing system in accordance with an illustrative embodiment;

FIG. 2 is an illustrative flow diagram of a syndication process in accordance with an aspect of the invention;

FIG. 3 is a schematic block diagram of a financing system in accordance with an aspect of the invention;

FIG. 4 is a flowchart of steps in an illustrative process for syndicating a financial obligation; and

FIG. 5 is a flowchart of steps of an illustrative method for syndicating a financing application.

### DETAILED DESCRIPTION

Various illustrative embodiments in accordance with aspects of the invention are described below in connection with a loan application, approved loan and/or portfolio of loans or loan applications. However, it should be understood that aspects of the invention may be used with other forms of financial obligations, including leases, lines of credit, factoring arrangements, insurance, letters of credit, and so on. Thus, aspects of the invention are not limited to loan applications or approved loans. However, various aspects of the invention may be particularly useful when processing loan applications.

In one illustrative embodiment in accordance with an aspect of the invention, a loan application or portfolio of applications may be syndicated automatically. Thus, approved or unapproved loan applications—singly or in groups—may be referred to other lenders or entities for their approval and/or joining in a syndication of the loan applications. The applications, or portfolio of applications, may be referred to other entities for syndication either in whole, or in one or more portions. Thus, in accordance with an aspect of the invention, a loan application that may be denied by a single lender may be referred to one or more syndication partners to spread the risk and together the syndication may approve the application. This feature may be useful when a lender is willing to approve a loan application on the condition that the risk of the loan be shared with other syndication partners. Thus, the lender need not deny the loan application, or approve the loan application and bear the risk that the loan might not later be syndicated. Instead, the lender may refer the application, or portions of the application, to other lenders to receive decisions from the other lenders indicating whether or not they will approve portions of the application. Based on the feedback received from the other lenders (syndication partners), the lender may approve a loan application that it otherwise may have declined, or accepted only on condition that it successfully syndicate the loan. This is also a benefit to applicants seeking approval of a loan application, because if the loan application would normally require syndication to be approved, automated syndication processing in accordance with various aspects of the invention may result in more rapid approval of the application, and a higher approval rate, than otherwise possible.

In another aspect of the invention, previously approved or issued loans, or portfolios of loans, may be automatically syndicated. Thus, a lender, or logic implemented on a computer system at the approval of the lender, may determine that one or more existing financial obligations should be syndicated. In another aspect of the invention, a set of syndication partners may be automatically determined, e.g., based on any suitable logic such as risk posed by the financial obligations, the geographic location of the borrower, a risk factor of the portfolio or obligation being syndicated, an amount of the financial exposure, the existence and/or type of collateral provided in connection with the financial obligation, and so on. Once one or more prospective syndication partners have been automatically identified, information may be sent to the prospective partners regarding one or more financial obligations, or one or more portions of financial obligations, for consideration. This information may be automatically received and processed, and a decision sent back to the lender originating the syndication process. Based on the responses, the lender may determine the syndication result, i.e., the outcome of the syndication processing.

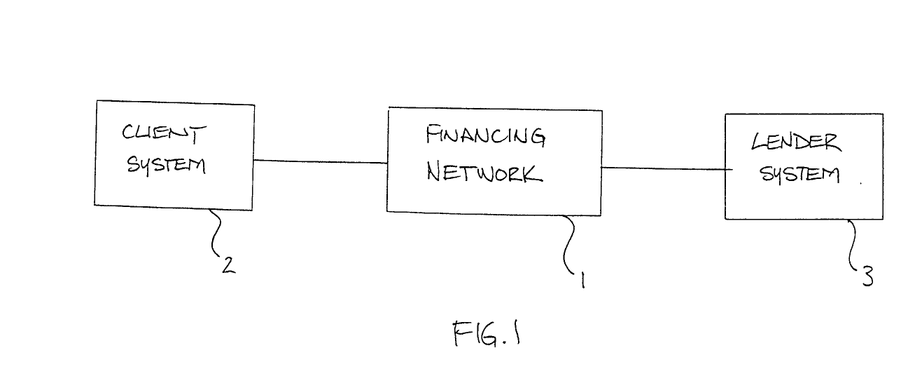

FIG. 1 is a schematic block diagram of a financing system adapted to operate in accordance with aspects of the invention. In one embodiment, a financing network 1 receives information regarding one or more financial obligations from a client system 2 and/or a lender system 3. The information may be, for example, one or more electronic messages regarding a loan application, an approved loan, or other financial obligation. In one illustrative embodiment, a user of a client system 2 may send an electronic message to the financing network 1 including a loan application. The financing network 1, the client system 2 and/or the lender system 3 may use the information regarding the financial obligation and automatically send information to another system within the financing network 1 to cause a syndication-related decision to be made for a lender or other entity to assume at least a portion of the financial obligation. In the embodiment where a client system 2 sends an electronic message including information regarding a loan application to the financing network 1, the financing network 1 may determine that the loan application is intended for a particular lender or lender system 3 and use any suitable logic and/or criteria to process the loan application on behalf of the lender (such logic and/or criteria typically being supplied in advance by the lender), or forward the loan application information to the particular lender system 3. At any point in processing the loan application, the financing network 1 or lender system 3 may determine that the loan application should be syndicated. For example, a decision to syndicate the loan application may be made either before or after the loan application is approved, based on processing performed by the financing network 1 and/or at a lender system 3. If the financing network 1 or lender system 3 determines that the loan application should be syndicated, the loan application may be divided into any suitable number of portions, and the portions subjected to decisioning by any suitable set of syndication partners. The syndication partners may be selected automatically by the financing network 1 or lender system 3 based on criteria such as the loan application amount, risk posed by the loan, and so on. Once the syndication partners have been identified, appropriate information may be sent from the financing network 1 or other source to associated lender systems 3 so that the lender systems 3 can determine whether the associated lender is willing to accept at least a portion of the risk of the syndication. If so, the lender system 3 may send a message indicating the lender's assent to join in the syndication.

Although in the example above a client system 2 provides information regarding a loan application, the financing system may be arranged to handle the syndication of other types of financial obligations, as well. For example, a client system 2 or lender system 3 may provide information regarding one or more approved loans or other financial obligations to the financing network 1. Based on this information, the financing network 1 may determine a set of lenders and/or lender systems 3 to which portions of the set of financial obligations may be sent for syndication consideration. The financing network 1 may automatically segment the set of financial obligations into information sets that are sent to respective lenders and/or lender systems 3. Alternately, a lender system 3 may automatically segment a set of financial obligations and forward the appropriate information sets to the respective lenders or lender system 3, either directly or through the financing network 1. The lender system 3 may automatically process the syndication requests and provide a decision regarding the proposed syndication. As discussed above, the syndication may involve any suitable set of financial obligations, such as approved loans, lines of credit, letters of credit, factoring arrangements, and so on.

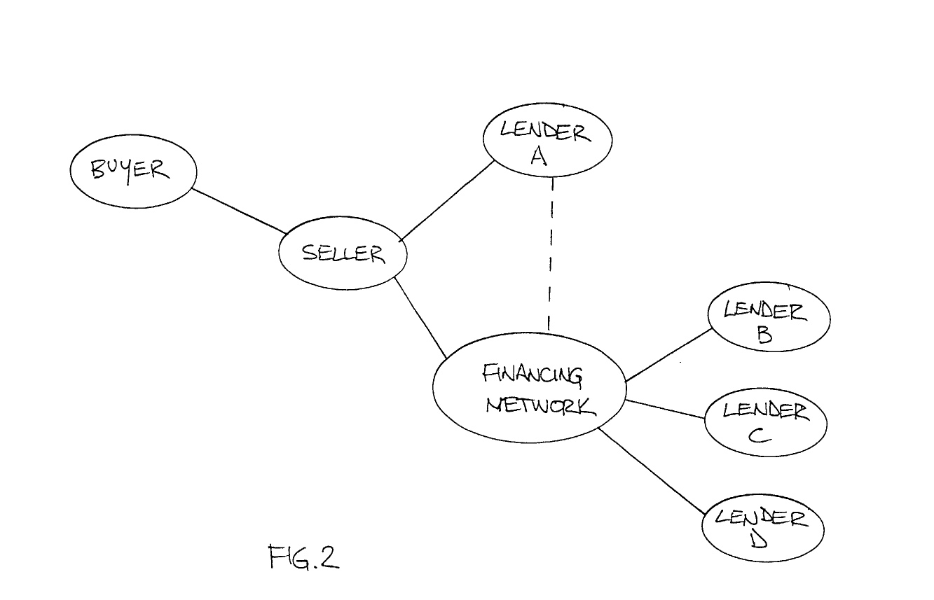

FIG. 2 shows an illustrative flow diagram for a syndication transaction. In this illustrative embodiment, a buyer is purchasing a good or service from a seller, and would like to obtain financing for the transaction. In accordance with aspects of the invention, the seller may forward a financing request, e.g., a loan application, electronically to a lender A and/or a financing network. The financing request may include typical loan application information, such as the buyer's identity, credit information, the loan principal and other terms, credit information, collateral information, and so on. Based on this information, the lender A may determine to approve or decline the loan application. The decision to approve or decline the loan application may be made at the lender A by a manual process, an automated, computerized process operating on the lender A's computer systems, or a combination of the two. Alternately, the decision to approve or decline the loan application may be made by a lender processing module operating within the financing network, for example, in a way described in U.S. patent application Ser. No. 09/684,208.

Whether the loan is approved or declined or at any other point in processing (e.g., after closing of a loan), the lender A may determine to syndicate the loan application or obligation. The decision to syndicate the loan application or obligation may be made automatically by computer systems operating under the control of lender A and/or by a syndication module operating within the financing network at the approval of lender A. The syndication module may determine whether and how to segment the loan application or obligation into two or more portions and/or determine a set of one or more lenders to be approached for proposed syndication. Electronic messages may then be sent either from the financing network or the lender A to the proposed syndication partners, in this example lenders B-D. Lenders B-D may process the proposed syndication requests in any suitable way, such as in a computer system operating under the control of each lender. Alternately, the lenders B-D may have processing modules operating within the financing network that receive the syndication requests and process the requests according to decisioning logic approved by the lender. Thus, syndication may occur entirely within the financing network with results of the syndication being forwarded to the lenders A-D when the syndication process is complete.

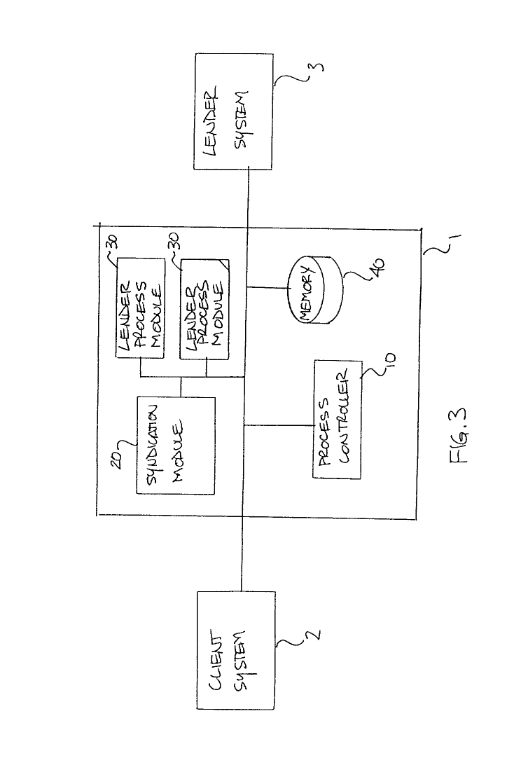

FIG. 3 shows a more detailed schematic block diagram of a financing system such as that shown in FIG. 1. In this illustrative embodiment, the financing network 1, the client system 2 and the lender system 3 may be general purpose data processing systems, which can be, or include, a suitably programmed general purpose computer, or network of general purpose computers, and other associated devices, including communication devices and/or other circuitry or components necessary to perform the desired input/output or other functions. The financing network 1, the client system 2 and the lender system 3 can also be implemented, at least in part, as single special purpose integrated circuits (e.g., ASICs), or an array of ASICs, each having a main or central processor section for overall, system level control and separate sections dedicated to performing various different specific computations, functions, and other processes under the control of the central processor section. The financing network 1, the client system 2 and lender system 3 can also be implemented using a plurality of separate dedicated programmable integrated or other electronic circuits or devices, e.g., hard-wired electronic or logic circuits, such as discrete element circuits or programmable logic devices. The systems 1, 2 and 3 may also include other devices, such as an information display device (e.g., a computer monitor, printer, facsimile device, etc.), user input devices, such as a keyboard, user pointing device, touch screen, graphical user interface or other user interface, data storage devices, such as a memory 40 which may include magnetic disk or tape storage devices, volatile or non-volatile semiconductor devices, optical disk storage devices, etc.

The financing network 1, client system 2 and lender systems 3 may communicate using any type of communication system, or combination of communication systems, such as wired or wireless telecommunications networks, radio or infrared communication systems, the Internet, one or more wide-area or local-area networks, and the like. Communications between the various systems may be performed in any suitable manner using any suitable protocol, language, data format or other arrangement. In addition, although FIGS. 1-3 show different numbers of client systems, financing networks and lender systems, any suitable number of these systems and networks may be used. Thus, aspects of the invention are not limited to any particular number of systems or networks, the hardware or software components used, the manner in which the systems communicate, and so on.

In this illustrative embodiment, the financing network 1 includes a process controller 10, a syndication module 20 and two lender process modules 30. The process controller 10, the syndication module 20, and lender process modules 30 may be implemented as software modules written in any suitable programming language that are executed on the financing network 1 or any other suitable data processing apparatus in any suitable environment. Alternately, these modules may be implemented as hard-wired electronic circuits or other programmed integrated or other electronic circuits or devices, e.g., hard-wired electronic or logic circuits, such as discrete element circuits or programmable logic devices. The financing network 1 is also not limited to any particular number of process controllers 10, syndication modules 20 and/or lender process modules 30. For example, the financing network 1 may include multiple process controllers 10 to allow parallel processing of different tasks and management of different sets of syndication modules 20 and/or lender process modules 30. A different syndication module 20 and/or lender process module 30 may be implemented for each lender associated with the financing network, multiple syndication modules and/or lender process modules may be maintained for one or more lenders, or syndication and lender decisioning may be combined into a single syndication module or lender process module.

The process controller 10 or other portions of the financing network 1 may include any other suitable components to perform various functions in processing financing transactions, such as a financing applications programming interface (API), process managers, and other manager components, such as those described in U.S. patent application Ser. Nos. 09/684,208 and 60/251,077.

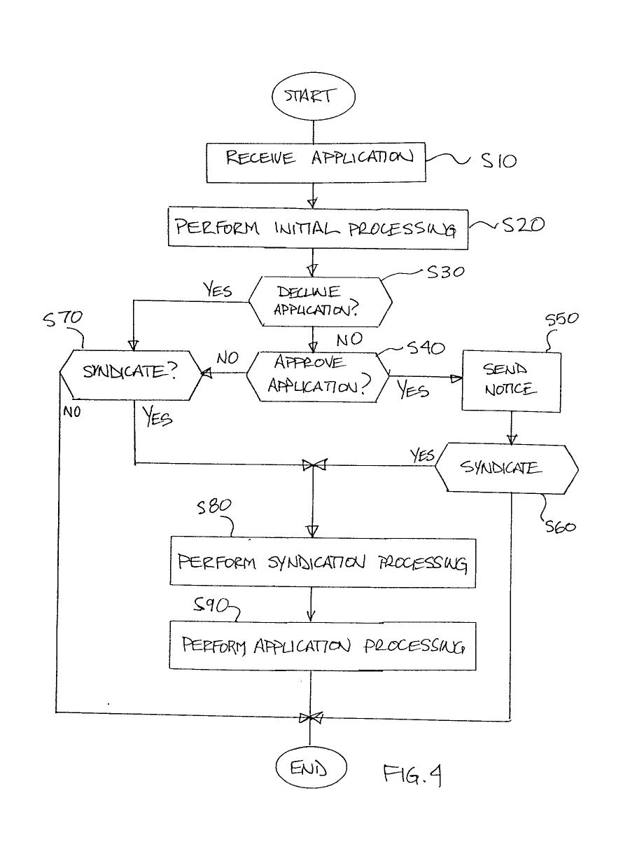

FIG. 4 is a flowchart of steps for an illustrative method in accordance with an aspect of the invention. Although performance of each of the steps in the flowchart is illustrated with reference to the components in the FIG. 3 embodiment, the method is not restricted to performance by the system shown in FIG. 3. Instead, the method may be performed by any suitable system.

In step S10 an application is received. As discussed above, although in this illustrative embodiment a loan application is received, any type of request to engage in any suitable type of financing obligation may be received, such as a factoring transaction, letter or line of credit, etc. In this illustrative example, the application may be received from the client system 2 in FIG. 3, which sends one or more electronic transmissions to the financing network 1. Together, the transmissions from the client system 2 may provide information regarding a financial obligation, in this case a loan application. The information may be sent and/or structured in any suitable way, such as by using a special purpose API or protocol for communications within a financial network. The application may be received by the process controller 10, which determines the nature and purpose of the communication, such as by analyzing the contents of the message(s) received from the client system 2.

In step S20, initial processing of the application or other information regarding a financial obligation is performed. Such initial processing may be performed by the process controller 10 and/or one or more lender process modules 30. For example, the process controller 10 may determine that an incoming loan application is directed to a particular set of one or more lenders. The process controller 10 may then forward information to one or more lender process modules 30 operating within the financing network 1 for processing. Alternately, or in addition, the process controller 10 may forward information regarding the application or other financial obligation to lender systems 3 outside of the financing network 1. The lender process modules 30 may perform any suitable initial processing of the information, such as determining an initial risk scoring for the application, gathering related credit information, etc. The initial processing may include relatively more simplified processing, such as receiving information regarding the financial obligation and determining an identity of the entity that forwarded the information.

In step S30, a determination is made whether to decline the application or not. For example, full, automated processing of a loan application may be completed in step S20, including gathering credit information and scoring of the application. In this case, a determination whether to decline the application may be made based on the scoring, e.g., the credit risk of the application. Of course, the determination whether to decline the application may be based on any suitable criteria and/or logic and may be performed manually, automatically or a combination of the two. For example, the application may be initially declined because the applicant does not live in a particular geographic region, state or country.

If the application is not declined, in step S40, a determination is made whether to approve the application. In some cases, the processing performed in step S20 may enable a determination whether to approve the application in step S40. In this case, a notice that the application has been approved may be sent in step S50. However, the processing in step S20 may not be sufficient to make a decision either to decline the application in step S30 or to approve the application in step S40. For example, the processing in steps S20, S30 or S40 may be only a preliminary, or initial stage processing, and not sufficient to subject the application to the complete decisioning logic required by a particular lender.

If the application is approved in step S40 and notification is sent in step S50, or if the application is declined in step S30 or not approved in step S40, a decision is made whether to syndicate the application in steps S60 or S70, respectively. The decision whether to syndicate the application may be performed in any suitable way by the syndication module 20. For example, if the application was approved in step S40, a decision may be made to divide the application into two or more portions so that the portions may be offered to other entities as part of a syndication or the entire application may be offered for syndication because the application poses too large a risk for the lender(s) that approved the application. Alternately, if the application was declined, a decision may be made to syndicate all or parts of the application so that the application can be approved by one or more other entities. For example, the syndication module 20 may determine based on a credit score given a particular application that the loan application should be syndicated. For example, an application having a lowest risk level A may not be syndicated, whereas an application having a lower risk level of B or C may be syndicated. If the application is to be syndicated, the application is subjected to syndication processing in step S80.

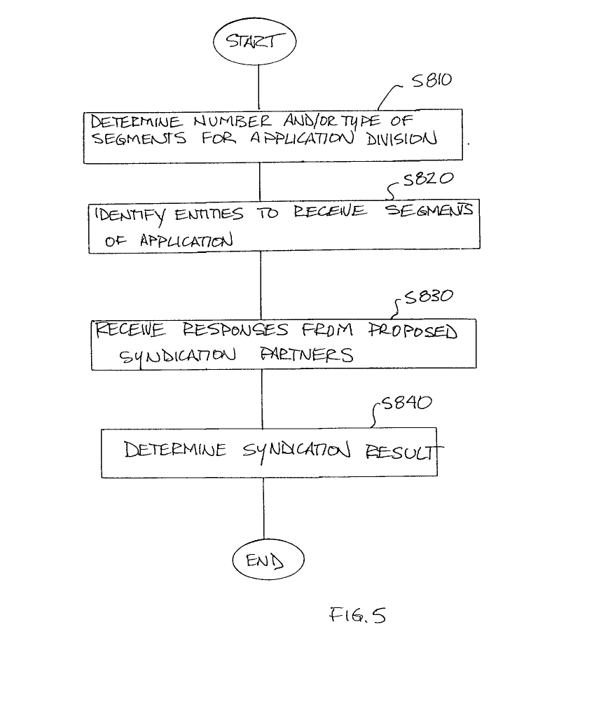

The syndication processing in step S80 may involve any suitable decisioning logic or consideration of criteria. Individual financial obligations may be syndicated, e.g., two or more entities may join in underwriting a single loan, or portfolios of financial obligations may be syndicated, e.g., two or more entities may join in underwriting a group of loans. Syndication may involve segmenting a single financial obligation; or a portfolio of obligations, into two or more portions, and having other entities assume responsibility for all or a part of the portions. Of course, it should be understood that these are only a few examples, and any suitable methods may be used to determine whether and how to syndicate one or a portfolio of financial obligations, such as those methods that are well-known in the art or developed in the future. Once the form of a syndication is determined, information may be sent by the syndication module 20 to prompt decisions to be made for other entities whether to join the syndication. The requests may identify particular portions of a financial obligation, a group of obligations, etc. that are part of a syndication proposal. Any other suitable information may be provided, such as credit information, the names of other entities that have joined the syndication, evaluation results for an obligation (such as a risk score for a loan application), and so on. Requests to entities to join in a syndication may be filtered based on various criteria, e.g., a request may not be sent to a lender to join in a syndication of a high risk loan if it is known that the lender will not assume all or a portion of the risk of the loan. The flowchart of FIG. 5 discussed in more detail below shows one illustrative example set of steps for performing the syndication processing of step S80.

Following syndication processing, application processing is performed in step S90. This further application processing in step S90 may involve a more complete analysis of the application to enable a decision to approve or decline the application, particularly if earlier processing was incomplete. The processing performed in step S90 may be any suitable type of processing, whether manually or automatically performed, and are well known in the art. In the case of loan application and other financing transaction processing, such process steps can vary widely depending upon the criteria determined for a lender, and is not discussed in detail herein.

FIG. 5 is an illustrative flowchart of steps for syndication processing in step S80 of FIG. 4. Again, the illustrative steps shown in FIG. 5 are only one example of the various different ways in which the syndication processing in step S80 may be performed and is provided for illustration purposes only. In step S810, a determination is made regarding the number and/or type of segments into which an application is to be divided for syndication. In one illustrative embodiment, a loan application may have two or more portions into which the application is logically divided, e.g., the application may involve financing for two separate pieces of equipment that are located in two separate geographic locations. In this case, the application may be divided into two segments, one segment for each piece of equipment. The application may also have two different types of segments, for example, a portion of a loan may be for completion of construction of a building, and a second portion of the loan may be for longer term financing of the building. In this case, the application may be segmented into portions corresponding to the construction completion and the longer term financing. The loan application may also be segmented based on the amount of total risk that a lender is willing to accept. For example, a $100,000 loan may be segmented into two or more parts, e.g., one $75,000 part that is retained by a lender and another $25,000 part that is offered for syndication. Other such segmentation schemes for loan applications, portfolios of loan applications, and other financial obligations or portfolios of financial obligations are well-known and not described in detail herein. It should be understood that any suitable method for segmenting a financial obligation or portfolio of financial obligations may be used in step S810 or in other syndication processing in accordance with aspects of the invention.

In step S820, entities that are intended to receive one or more segments of the syndicated application or other financial obligation are selected. Again, this determination may be performed based on any suitable criteria. For example, a risk factor determined for a segment of a loan application may be used to determine which lender or lenders are requested to assume the loan application segment in a syndication scheme. In some cases, lenders may only be willing to accept low risk application segments, while other lenders may be willing to accept higher risk portions. Determination of proposed syndication partners may be determined based on other factors, such as geographic location, past business practices (such as a long term relationship between lenders), random selection, the identity of the lendee or other customer, and so on.

In step S830, responses from the proposed syndication partners are received. Thus, after the syndication partners have received requests to assume one or more segments of a financial obligation or a portfolio of financial obligations, the syndication partners may process the request using any suitable method and provide their responses to the request. The responses may take any suitable form, such as an approval to assume one or more portions of a financial obligation, a request for additional information, a request for alteration in the financial obligation segmentation, etc.

In step S840, a syndication result is determined. For example, a financial obligation or portfolio of financial obligations may be segmented into multiple portions that are submitted to multiple potential syndication partners. These partners may have assessed the various portions of the syndication and provided their responses. Based on these responses, the final syndication result may be determined. In some cases, the result may be determined based on identifying which syndication partners have approved which segments of the syndication. In other cases, the syndication may involve an auctioning of one or more portions of the syndication, and syndication partners may provide a bid for one or more segments. The syndication segments may be awarded to the highest bidder, or bidder meeting any other suitable requirements.

While aspects of the invention have been described in conjunction with specific embodiments, it is evident that many alternatives, modifications and variations will be apparent to those skilled in the art. Accordingly, preferred embodiments in accordance with various aspects of the invention are intended to be illustrative, and not limiting. Various changes may be made without departing from the spirit and scope of the invention.

What is claimed:

1. A system for syndicating financial obligations, comprising:
a process controller that receives information regarding a financial obligation of a first entity that has not been approved by the first entity; and
a syndication module that automatically sends information regarding the financial obligation to prompt a decision from a second entity different from the first entity about assuming at least a portion of the financial obligation.

2. The system of claim 1, wherein the syndication module analyzes at least part of the information regarding the financial obligation to select the second entity.

3. The system of claim 1, wherein the financial obligation is a loan.

4. The system of claim 1, wherein the financial obligation includes a loan that has not been approved by the first entity.

5. The system of claim 1, further comprising a process module adapted to determine whether the first entity will accept the financial obligation, and wherein the financial obligation includes a loan, the process module determining that the loan is approved by the first entity after a decision is made for the second entity to assume at least a portion of the financial obligation.

6. The system of claim 1, further comprising a process module adapted to determine whether the first entity will accept the financial obligation, and wherein the financial obligation is a loan and the first entity is a first lender, the process module determining that the first lender will approve the loan after a decision is made for the second entity to assume a risk of at least a portion of the loan.

7. The system of claim 1, further comprising:
a first lender process module that processes the information regarding the financial obligation received by the process controller and determines whether the first entity will accept the financial obligation; and
a second lender process module that receives the information from the syndication module and determines if the second entity will accept at least a portion of the financial obligation.

8. The system of claim 7, wherein the first lender process module determines that the first entity will not accept the financial obligation.

9. The system of claim 7, wherein the first lender process module determines that the first entity will accept only a portion of the financial obligation, and the second lender process module determines that the second entity will accept another portion of the financial obligation.

10. The system of claim 1, wherein the process controller receives information regarding a plurality of financial obligations of the first entity, and the syndication module sends information regarding the plurality of financial obligations so that decisions are made for at least one other entity whether to accept a portion of the plurality of financial obligations.

11. The system of claim 1, wherein the syndication module selects the second entity based on one of a credit risk posed by the financial obligation, and a geographic parameter related to the financial obligation.

12. The system of claim 1, wherein the syndication module is adapted to auction portions of a financial obligation or a portfolio of financial obligations to a plurality of entities.

13. A method for syndicating financial obligations, comprising:
receiving electronic information regarding a financial obligation of a first entity that has not been approved by the first entity; and
automatically sending information regarding the financial obligation to prompt a decision by a second entity different from the first entity about assuming at least a portion of the financial obligation.

14. The method of claim 13, further comprising analyzing at least a portion of the information regarding the financial obligation to select the second entity.

15. The method of claim 13, wherein the financial obligation is a loan.

16. The method of claim 13, wherein the financial obligation includes a loan that has not been approved by the first entity.

17. The method of claim 13, further comprising:
receiving information representing a decision of the second entity to assume at least a portion of the financial obligation; and
receiving information representing a decision of the first entity to approve the financial obligation after receiving information representing a decision of the second entity.

18. The method of claim 13, further comprising receiving information representing a decision of the first entity to approve the financial obligation.

19. The method of claim 13, further comprising:
automatically processing the information regarding the financial obligation and determining whether the first entity will accept the financial obligation;
receiving the information automatically sent regarding the financial obligation to prompt a decision made for the second entity; and
determining whether the second entity will accept at least a portion of the financial obligation.

20. The method of claim 19, wherein the step of automatically processing the information comprises determining that the first entity will not accept the financial obligation.

21. The method of claim 19, wherein the step of automatically processing the information comprises determining that the first entity will accept only a first portion of the financial obligation, and the step of determining whether the second entity will accept at least a portion of the financial obligation comprises determining that the second entity will accept a second portion of the financial obligation.

22. The method of claim 13, wherein the step of receiving information regarding a financial obligation of a first entity comprises receiving information regarding a plurality of financial obligations of the first entity, and the step of automatically sending information regarding the financial obligation comprises sending information regarding the plurality of financial obligations so that decisions are made for at least one other entity whether to accept a portion of the plurality of financial obligations.

23. The method of claim 13, further comprising selecting the second entity based on one of a credit risk posed by the financial obligation, and a geographic parameter related to the financial obligation.

24. The method of claim 13, further comprising auctioning portions of a financial obligation or a portfolio of financial obligations to a plurality of entities.

25. A system for syndicating financial obligations, comprising:
a process controller that receives information regarding a financial obligation of a first entity; and
a syndication module that identifies at least one second entity different from the first entity as a possible syndication partner without prompting from the at least one second entity and automatically sends information regarding the financial obligation to prompt a decision by the at least one second entity about assuming at least a portion of the financial obligation.

26. The system of claim 25, wherein the syndication module analyzes at least a part of the information regarding the financial obligation to identify the at least one second entity.

27. The system of claim 25, wherein the financial obligation is a loan.

28. The system of claim 25, wherein the financial obligation includes a loan that has not been approved by the first entity.

29. The system of claim 25, wherein the financial obligation includes a loan that has been approved by the first entity.

30. The system of claim 25, wherein the financial obligation is a loan and the first entity is a first lender that approved the loan.

31. The system of claim 25, further comprising:
a first lender process module that processes the information regarding the financial obligation and determines whether the first entity will accept the financial obligation; and
a second lender process module that receives the information from the syndication module and determines if the at least one second entity will accept at least a portion of the financial obligation.

32. The system of claim 31, wherein the first lender process module determines that the first entity will not accept the financial obligation.

33. The system of claim 31, wherein the first lender process module determines that the first entity will accept only a portion of the financial obligation, and the second lender process module determines that the second entity will accept another portion of the financial obligation.

34. The system of claim 25, wherein the process controller receives information regarding a plurality of financial obligations of at least the first entity, and the syndication module sends information regarding the plurality of financial obligations so that decisions are made for at least one other entity whether to accept a portion of the plurality of financial obligations.

35. A method for syndicating financial obligations, comprising:
receiving electronic information regarding a financial obligation of a first entity;
automatically selecting a second entity different from the first entity as a possible syndication partner; and
automatically sending information regarding the financial obligation to prompt a decision by a second entity about assuming at least a portion of the financial obligation.

36. The method of claim 35, wherein the step of automatically selecting a second entity comprises analyzing the information regarding the financial obligation to select the second entity.

37. The method of claim 35, wherein the financial obligation is a loan.

38. The method of claim 35, wherein the financial obligation includes a loan that has not been approved by the first entity.

39. The method of claim 35, further comprising:
receiving information representing a decision of the second entity to assume at least a portion of the financial obligation; and
receiving information representing a decision of the first entity to approve the financial obligation after receiving information representing a decision of the second entity.

40. The method of claim 35, further comprising receiving information representing a decision of the first entity to approve the financial obligation.

41. The method of claim 35, further comprising:
automatically processing the information regarding the financial obligation and determining whether the first entity will accept the financial obligation;
receiving the information automatically sent regarding the financial obligation to prompt a decision made for the second entity; and
determining whether the second entity will accept at least a portion of the financial obligation.

42. The method of claim 41, wherein the step of automatically processing the information comprises determining that the first entity will not accept the financial obligation.

43. The method of claim 41, wherein the step of automatically processing the information comprises determining that the first entity will accept only a first portion of the financial obligation, and the step of determining whether the second entity will accept at least a portion of the financial obligation comprises determining that the second entity will accept a second portion of the financial obligation.

44. The method of claim 35, wherein the step of receiving information regarding a financial obligation of a first entity comprises receiving information regarding a plurality of financial obligations of the first entity, and the step of automatically sending information regarding the financial obligation comprises sending information regarding the plurality of financial obligations so that decisions are made for at least one other entity whether to accept a portion of the plurality of financial obligations.

45. The method of claim 35, wherein the step of automatically selecting a second entity comprises selecting the second entity based on one of a credit risk posed by the financial obligation, and a geographic parameter related to the financial obligation.

46. The method of claim 35, further comprising auctioning portions of a financial obligation or a portfolio of financial obligations to a plurality of entities.

47. A method for syndicating at least one loan obligation, comprising:
receiving electronic information regarding a loan obligation of a first entity;
automatically selecting a second entity different from the first entity as a possible syndication partner in a syndication of the loan obligation; and
automatically sending computer-readable information regarding the loan obligation to prompt a decision by a second entity about assuming at least a portion of the financial obligation.

48. A computer readable storage medium including instructions to cause a data processing system to perform the steps of claim 47.

49. A method for syndicating a financial obligation, comprising:
receiving electronic information regarding a loan transaction;
determining whether to decline or approve the loan transaction;
determining to syndicate the loan transaction;
automatically selecting syndication partners; and
sending electronic information to prompt a decision by the syndication partners whether to join in the syndication of the loan transaction.
